(19) United States
(12) Patent Application Publication
(10) Pub. No.: US 2025/0360620 A1
(43) Pub. Date: Nov. 27, 2025

(54) ROBOT SYSTEM, ROBOT DEVICE, ROBOT CONTROLLER, END EFFECTOR AND END EFFECTOR CONTROL METHOD

(71) Applicant: YAMAHA HATSUDOKI KABUSHIKI KAISHA, Iwata-shi, Shizuoka (JP)

(72) Inventor: Haruyasu FUJITA, Iwata-shi (JP)

(73) Assignee: YAMAHA HATSUDOKI KABUSHIKI KAISHA, Iwata-shi, Shizuoka (JP)

(21) Appl. No.: 18/689,225

(22) PCT Filed: Sep. 28, 2021
(86) PCT No.: PCT/JP2021/035563

§ 371 Date: Feb. 3, 2025

(51) Int. Cl. B25J 9/16

(52) U.S. Cl. CPC B25J 9/1664

(57) ABSTRACT

The memory unit 34 storing the control information (API 521 and operation macro code 522) used by the robot controller 4 (robot controller) to control the end effector 3 is provided in the end effector 3. Therefore, by obtaining the control information from the memory unit 34 provided in the end effector 3 to be controlled, the robot controller 4 can reliably obtain the control information corresponding to this end effector 3 (Steps S102 to S104).

### TECHNICAL FIELD

This invention relates to a technique for controlling an end effector to be attached to a robot.

### BACKGROUND ART

As shown in patent literature 1, a robot is generally caused to perform an operation by controlling the robot such as a machine tool by a robot controller. Further, an end effector attached to the robot can be used to perform the operation.

### CITATION LIST

### Patent Literature

Patent literature 1: WO 2013/094868

### SUMMARY OF INVENTION

### Technical Problem

At this time, the robot controller needs to control the end effector using control information prepared in advance for the end effector attached to the robot. However, such end effector control information has been provided separately from the robot while being saved, for example, in a USB memory or the like. Thus, for example, at a work site using a plurality of end effectors, a correspondence between the end effectors and the control information has needed to be managed. However, there have been cases where, as a result that such a management has not been properly performed, the robot controller erroneously executes a control based on the control information not corresponding to the end effector attached to the robot.

This invention was developed in view of the above problem and aims to enable a robot controller to reliably obtain control information corresponding to an end effector to be controlled.

### Solution to Problem

A robot system according to the invention, comprises: a robot; an end effector to be detachably attached to the robot; and a robot controller configured to control the robot and the end effector, wherein the end effector includes a memory unit that saves control information used by the robot controller to control the end effector, and the robot controller controls the end effector by the control information obtained from the memory unit.

A robot device according to the invention, comprises: a robot to which an end effector is to be detachably attached; and a robot controller configured to control the robot and the end effector, wherein the end effector including a memory unit that saves control information used by the robot controller to control the end effector, and the robot controller controlling the end effector by the control information obtained from the memory unit.

A robot controller according to the invention is a robot controller for controlling a robot and an end effector to be detachably attached to the robot, and comprises: a control unit configured to control the robot and the end effector, wherein the end effector includes a memory unit that saves control information used by the robot controller to control the end effector, and the control unit controls the end effector by the control information obtained from the memory unit.

An end effector according the invention is an end effector is to be detachably attached to a robot, and comprises: a memory unit that saves control information used by a robot controller to control the end effector.

An end effector control method according to the invention, comprises: obtaining control information used to control an end effector from a memory unit provided in the end effector by a robot controller; and controlling the end effector by the control information obtained from the memory unit by the robot controller.

In the invention thus configured (robot system, robot device, robot controller, end effector and end effector control method), the memory unit that saves the control information used by the robot controller to control the end effector is provided in the end effector. Therefore, the robot controller can reliably obtain the control information corresponding to this end effector by obtaining the control information from the memory unit provided in the end effector to be controlled.

The robot system may be configured so that the robot controller obtains the control information from the memory unit if the end effector is attached to the robot. In such a configuration, the control information corresponding to the end effector attached to the robot can be reliably obtained.

The robot system may be configured so that the robot controller causes the robot and the end effector to perform a predetermined operation in cooperation, the operation includes a robot operation performed by the robot and an end effector operation performed by the end effector, and the robot controller causes the end effector to perform the end effector operation by controlling the end effector based on the control information obtained from the memory unit. In such a configuration, the robot controller can cause the robot and the end effector to perform a predetermined operation while precisely controlling the end effector based on the control information corresponding to the end effector attached to the robot.

The robot system may be configured so that the robot controller creates a work program that defines the end effector operation, based on the control information, saves the work program in the memory unit of the end effector and causes the end effector to perform the end effector operation by executing the work program obtained from the memory unit. In such a configuration, the work program that defines the end effector operation to be performed by the end effector is created based on the control information corresponding to this end effector, and saved in the memory unit of the end effector. When performing the operation, the robot controller obtains the work program from the memory unit of the end effector and executes the work program. Therefore, the robot controller can reliably cause the end effector to perform the end effector operation based on the work program corresponding to the end effector. Note that, if a plurality of work programs can be saved, the work program selected by operator's selection or a command given by communication from outside can be executed.

The robot system may be configured so that the work program further defines the robot operation, and the robot controller causes the robot to perform the robot operation and causes the end effector to perform the end effector operation by executing the work program obtained from the memory unit. In such a configuration, the work program defining the operation to be performed by the robot and the end effector is created based on the control information corresponding to the end effector and saved in the memory unit of the end effector. When performing the operation, the robot controller obtains the work program from the memory unit of the end effector and executes the work program. Therefore, the robot controller can reliably cause the robot and the end effector to perform the operation.

Some end effectors include a data acquirer such as a camera or sensor for obtaining data on a work, and a robot controller may be required to perform a signal processing on the data. Accordingly, to deal with such a case, some robot controllers have been equipped with an arithmetic function of performing this signal processing. However, in a situation of using the end effector that does not obtain this data, the robot controller is equipped with an excessive arithmetic function.

The robot system may be configured so that the end effector further includes a data acquirer configured to obtain data on the work and an arithmetic unit configured to perform a predetermined signal processing on the data obtained by the data acquirer.

In such a configuration, since the end effector includes the arithmetic unit configured to perform the signal processing, the robot controller is not required to perform the signal processing. Therefore, the robot controller does not need to be equipped with an excessive arithmetic function.

Various specific examples of the data acquirer obtaining data on the work are supposed. For example, the robot system may be configured so that the data acquirer is a camera that obtains an image of the work, and the arithmetic unit performs an image processing on the image obtained by the camera.

The robot system may be configured so that the memory unit saves display information for displaying a model of the end effector and a setting screen for setting an operation of the end effector, and the robot controller performs display on a display according to the display information obtained from the memory unit. In such a configuration, the robot controller can reliably display the model of the end effector and the setting screen for setting the operation of the end effector on the display based on the display information obtained from the memory unit of the end effector.

The display information may be described in an HTML (HyperText Markup Language). In such a configuration, the memory unit of the end effector functions as a web server. If the robot controller transmits an HTTP request requesting the display information to the memory unit, the memory unit transmits the display information as an HTTP response to the robot controller. In this way, the display on a GUI based on the display information can be easily made by HTTP communication between the robot controller and the memory unit of the end effector.

The robot system may be configured so that the control information includes an execution code representing an operation to be performed by the end effector, and the robot controller causes the end effector to perform the operation represented by the execution code by transmitting the execution code to the end effector. In such a configuration, the robot controller can reliably obtain the execution code corresponding to the end effector by obtaining the execution code from the memory unit provided in the end effector to be controlled.

The execution code may be described in an intermediate code. Hereby, the robot controller can execute the execution code without depending on a CPU thereof.

The execution code may be described in an interpreter language. Hereby, the robot controller can execute the execution code without depending on the CPU thereof.

The robot system may be configured so that the robot controller and the end effector are connected by a USB (Universal Serial Bus), and out of a plurality of end points of the USB, one end point is used for communication between the robot controller and the end effector, and another end point different from the one end point is used by the robot controller to use the memory unit of the end effector as a storage. In such a configuration, the control information can be transmitted from the memory unit of the end effector to the robot controller using the one end point of the USB. Further, the other end point used by the robot controller to use the memory unit of the end effector as a storage is provided in the USB. Therefore, the robot controller can recognize contents of the memory unit of the end effector as a file. As a result, a developer can easily refer to the contents of the memory unit of the end effector and the developer's burden can be reduced.

The robot system may be configured so that the robot controller and the end effector are connected by a LAN (Local Area Network), and out of a plurality of ports of the LAN, one port is used for communication between the robot controller and the end effector, and another port different from the one port is used by the robot controller to use the memory unit of the end effector as a storage. In such a configuration, the control information can be transmitted from the memory unit of the end effector to the robot controller using the one port of the LAN. Further, the other port used by the robot controller to use the memory unit of the end effector as a storage is provided in the LAN. Therefore, the robot controller can recognize contents of the memory unit of the end effector as a file. As a result, the developer can easily refer to the contents of the memory unit of the end effector and the developer's burden can be reduced.

### Effect of Invention

According to the invention, it is possible for a robot controller to reliably obtain control information corresponding to an end effector to be controlled.

### BRIEF DESCRIPTION OF THE DRAWINGS

FIG. 1 is a diagram schematically showing an example of a robot system according to the invention.

FIG. 2 is a block diagram showing an electrical configuration included in the robot system of FIG. 1.

FIG. 3A is a table schematically showing an example of the command set.

FIG. 3B is a diagram schematically showing a function of the HTML file.

FIG. 4 is a flow chart showing an example of information acquisition performed by the arithmetic unit of the robot controller.

FIG. 5 is a flow chart showing an example of the creation of a work program for causing the robot arm and the end effector to perform an operation.

FIG. 6 is a chart schematically showing operations to be performed based on the flow chart of FIG. 5.

FIG. 7 is a flow chart for causing the robot arm and the end effector to perform the operation.

FIG. 8 is a diagram schematically showing a modification of the robot system according to the invention.

FIG. 9 is a block diagram showing an electrical configuration of the robot system of FIG. 8.

FIG. 10A is a diagram schematically showing a first example of the connection mode of the respective communicators of the robot controller and the end effector.

FIG. 10B is a diagram schematically showing a second example of the connection mode of the respective communicators of the robot controller and the end effector.

### DESCRIPTION OF EMBODIMENTS

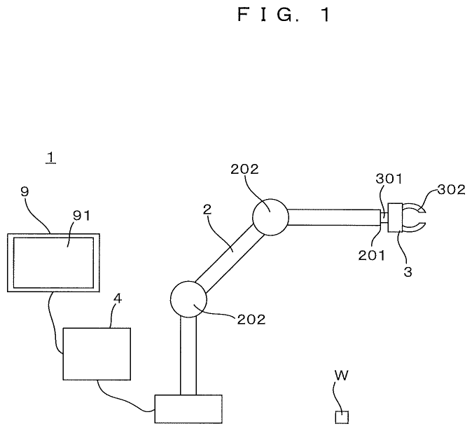

FIG. 1 is a diagram schematically showing an example of a robot system according to the invention. The robot system 1 of FIG. 1 comprises a robot arm 2, an end effector 3 to be detachably attached to a tip 201 of the robot arm 2, a robot controller 4 configured to control the operations of the robot arm 2 and the end effector 3, and a teaching pendant 9 connected to the robot controller 4. The teaching pendant 9 includes a display 91 (in other words, a graphical user interface), and displays an image corresponding to a command of the robot controller 4 on the display 91.

The robot arm 2 is an articulated robot having the tip 201, to which the end effector 3 is attached, changes the position and posture of the end effector 3 attached to the tip 201 by rotating joints 202 in response to a command from the robot controller 4.

The end effector 3 includes an attachment part 301 to be detachably attached to the tip 201 of the robot arm 2 and an operation part 302 mounted on the attachment part 301. The attachment part 301 is attached to the tip 201 of the robot arm 2, for example, by a mechanism such as a latch lock or screwing. The operation part 302 is a mechanical configuration for performing an operation for a work W and, in an example of FIG. 1, a gripper for gripping the work W. However, a specific example of the operation part 302 is not limited to the gripper, but may be an instrument for suction by a negative pressure or magnetic force, an instrument for welding, polishing or screwing or the like. The end effector 3 causes the operation part 302 to operate in response to a command from the robot controller 4.

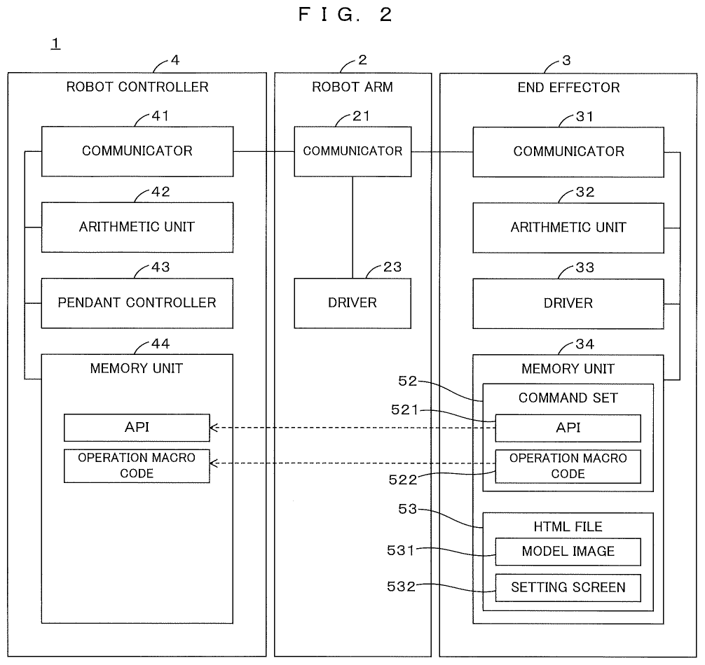

FIG. 2 is a block diagram showing an electrical configuration included in the robot system of FIG. 1. The robot arm 2, the end effector 3 and the robot controller 4 respectively include a communicator 21, a communicator 31 and a communicator 41, and communication is carried out among the communicators 21, 31 and 41. Note that either wireless or wired communication can be carried out among these, but the wired communication is carried out in this example. Particularly, since the robot arm 2 and the end effector 3 are detachably attachable as described above, communication is carried out between the communicator 31 of the end effector 3 and the communicator 21 of the robot arm 2 with the end effector 3 attached to the robot arm 2. Further, the communicator 41 of the robot controller 4 communicates with the communicator 21 of the robot arm 2 and communicates with the communicator 31 of the end effector 3 attached to the robot arm 2 via the robot arm 2. Note that the communication between the communicator 41 and the communicator 31 via the robot arm 2 may be carried out via the communicator 21 or may be carried out via a wiring provided in the robot arm 2 separately from the communicator 21 (i.e. without via the communicator 21). On the other hand, the communication between the communicator 21 of the robot arm 2 and the communicator 31 of the end effector 3 is disabled with the end effector 3 detached from the robot arm 2.

The robot controller 4 further includes an arithmetic unit 42, a pendant controller 43 and a memory unit 44. The arithmetic unit 42 is a processor constituted by a CPU (Central Processing Unit) and the like, and performs various processings such as the control of the teaching pendant 9 via the pendant controller 43, the writing of data in the memory unit 44 and the read-out of data from the memory unit 44, communication by the communicator 41 and the like. The pendant controller 43 displays an image on the display 91 of the teaching pendant 9 and performs a calculation and the like corresponding to an input operation of a developer to the teaching pendant 9. The memory unit 44 is a memory device storing data in an HDD (Hard Disk Drive) or SSD (Solid State Drive).

The robot arm 2 further includes a driver 23 driving the joints 202 of the robot arm 2, using a motor, an actuator or the like. The driver 23 adjusts the position and posture of the end effector 3 attached to the robot arm 2 by driving the joints 202 of the robot arm 2 in response to a command received from the communicator 41 of the robot controller 4 by the communicator 21.

The end effector 3 further includes an arithmetic unit 32, a driver 33 and a memory unit 34. The arithmetic unit 32 is a processor constituted by a CPU or the like. The driver 33 drives the operation part 302 (gripper in this example) of the end effector 3 by a motor, an actuator or the like. This driver 33 drives the operation part 302 in response to a command received from the communicator 41 of the robot controller 4 by the communicator 31. If the operation part 302 is a gripper, the driver 33 adjusts angles of fingers of the gripper, a torque for gripping the work W by the fingers of the gripper and the like in response to a command from the robot controller 4.

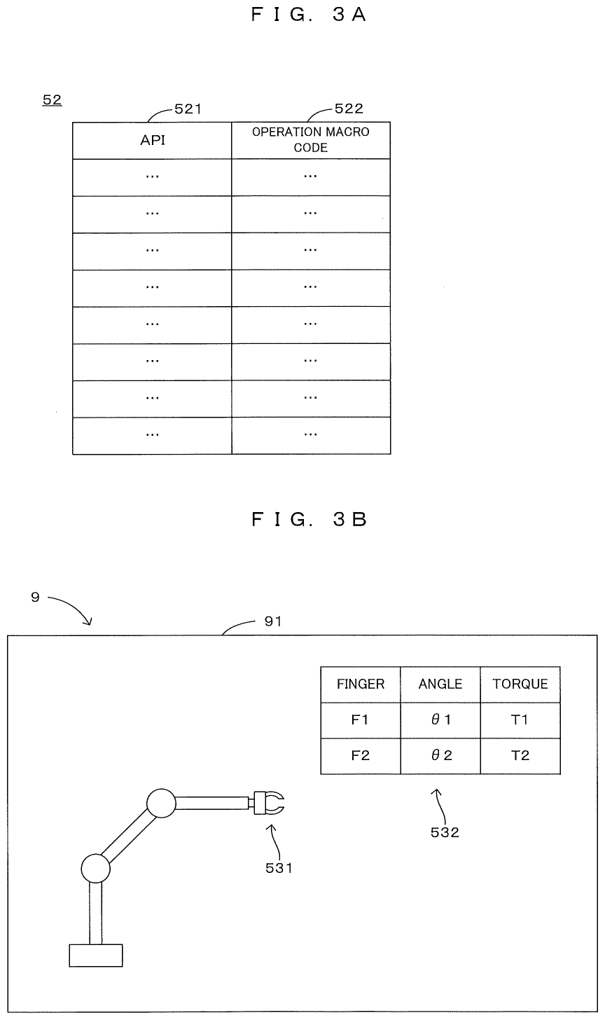

Further, the memory unit 34 is a memory device storing data in an HDD or SSD. This memory unit 34 saves a command set 52 and an HTML (HyperText Markup Language) file 53. The command set 52 includes APIs (Application Programming Interfaces) 521 and operation macro codes 522 for causing the end effector 3 to perform a predetermined operation as shown in FIG. 3A next. The API 521 is an interface used by the robot controller 4 to cause the end effector 3 to perform a predetermined operation, and the operation macro code 522 is a command representing the execution of a predetermined operation. That is, the robot controller 4 transmits the operation macro code 522 to the driver 33 of the end effector 3 by executing the API 521 after transferring the API 521 and the operation macro code 522 from the memory unit 34 of the end effector 3 to the memory unit 44 thereof.

FIG. 3A is a table schematically showing an example of the command set. As shown in FIG. 3A, the command set 52 indicates a correspondence of the API 521 and the operation macro code 522 for each of a plurality of operations. The operation macro code 522 is equivalent to a command representing an operation to be performed by the operation part 302 of the end effector 3. That is, if the arithmetic unit 42 of the robot controller 4 executes the API 521, the operation macro code 522 corresponding to the API 521 is transmitted from the robot controller 4 to the driver 33 of the end effector 3 and the driver 33 causes the operation part 302 to perform the operation represented by the operation macro code 522. If the operation part 302 is the gripper, the APIs 521 and the operation macro codes 522 for performing each of operations including:
an operation of opening the gripper,
an operation of changing a rotation angle of the fingers of the gripper to a predetermined angle, and
an operation of giving a predetermined torque to the fingers of the gripper, are included in the command set 52 while being associated with each other.

FIG. 3B is a diagram schematically showing a function of the HTML file. The HTML file 53 represents contents to be displayed on the display 91 of the teaching pendant 9 and specifically includes a model image 531 and a setting screen 532. The model image 531 represents an image of the end effector 3 to be displayed on the display 91 of the teaching pendant 9, and the arithmetic unit 42 of the robot controller 4 synthesizes a model image of the robot arm 2 obtained in advance and the model image 531 of the end effector 3 obtained from the memory unit 34 of the end effector 3, and displays images of the robot arm 2 and the end effector 3 on the display 91 of the teaching pendant 9. Further, the setting screen 532 is a screen for setting an operation to be performed by the operation part 302 of the end effector 3, and the arithmetic unit 42 of the robot controller 4 displays the setting screen 532 obtained from the memory unit 34 of the end effector 3 on the display 91 of the teaching pendant 9. Therefore, the developer can set the operation to be performed by the operation part 302 of the end effector 3 to the robot controller 4 by performing an input operation to the setting screen 532 using an input function of the teaching pendant 9.

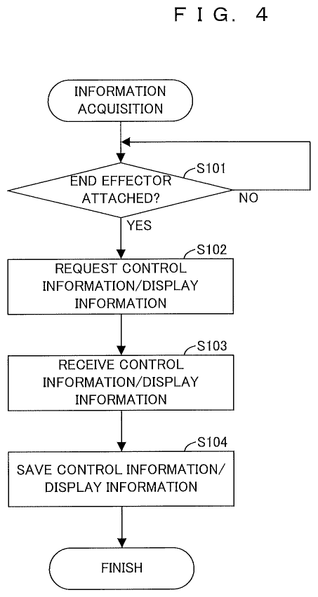

FIG. 4 is a flow chart showing an example of information acquisition performed by the arithmetic unit of the robot controller. In the information acquisition of FIG. 4, information required for the control of the end effector 3 is obtained from the end effector 3 by the robot controller 4.

In Step S101, the arithmetic unit 42 judges whether or not the end effector 3 is attached to the robot arm 2. As described above, the communication between the communicator 31 of the end effector 3 and the communicator 21 of the robot arm 2 can be carried out with the end effector 3 attached to the robot arm 2, but cannot be carried out without the end effector 3 being attached to the robot arm 2. Accordingly, in Step S101, the arithmetic unit 42 judges that the end effector 3 is not attached to the robot arm 2 (NO) if the communication cannot be carried out between the communicator 31 and the communicator 21, and judges that the end effector 3 is attached to the robot arm 2 (YES) if the communication can be carried out between the communicator 31 and the communicator 21. However, the attachment of the end effector 3 to the robot arm 2 can be confirmed regardless of whether or not the communication between these is possible. For example, the attachment of the robot arm 2 and the end effector 3 may be detected by a proximity sensor, an optical sensor or the like.

In Step S102, the arithmetic unit 42 transmits an information request command requesting control information used to control the end effector 3 (i.e. API 521 and operation macro code 522) and display information representing contents to be displayed on the display 91 (i.e. HTML file 53) to the communicator 31 of the end effector 3 via the communicator 41. The communicator 31 of the end effector 3 reads out the API 521, the operation macro code 522 and the HTML file 53 from the memory unit 34 and transmits these to the communicator 41 of the robot controller 4 in response to the information request command received from the robot controller 4, and the communicator 41 of the robot controller 4 receives these (Step S103). Particularly, in the transmission and reception of the HTML file 53, the memory unit 34 of the end effector 3 functions as a web server. That is, if the arithmetic unit 42 transmits an HTTP request requesting the HTML file 53 to the arithmetic unit 32 via the communicator 31, the arithmetic unit 32 transmits the HTML file 53 read out from the memory unit 34 as an HTTP response to the robot controller 4 via the communicator 31. Then, the arithmetic unit 42 saves the API 521, the operation macro code 522 and the HTML file 53 received by the communicator 41 in the memory unit 44.

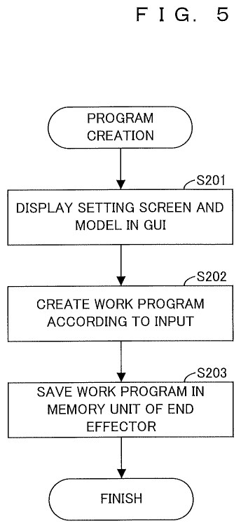

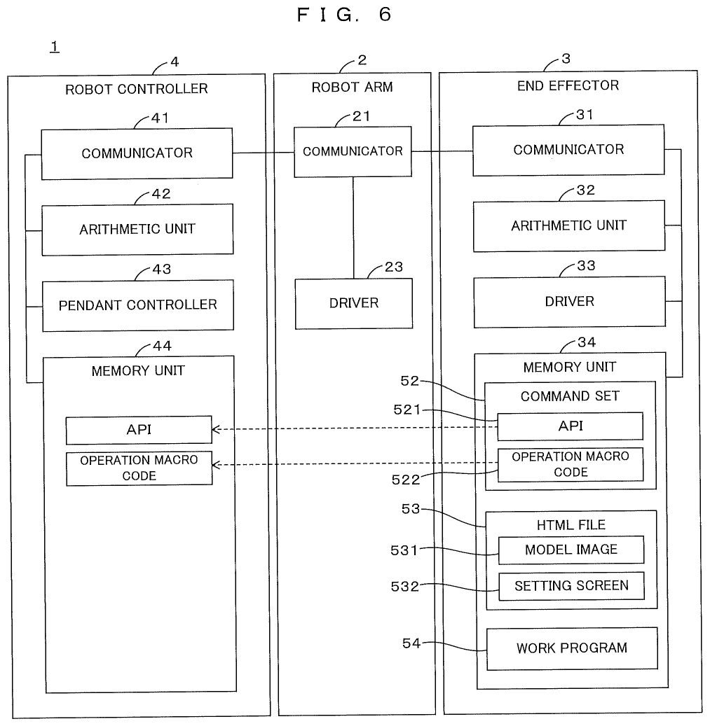

FIG. 5 is a flow chart showing an example of the creation of a work program for causing the robot arm and the end effector to perform an operation, and FIG. 6 is a chart schematically showing operations to be performed based on the flow chart of FIG. 5. The flow chart of FIG. 5 is performed by the arithmetic unit 42 of the robot controller 4.

In Step S201, the arithmetic unit 42 reads out the HTML file 53 received from the end effector 3 and saved in the memory unit 44 and displays the HTML file 53 on the display 91 of the teaching pendant 9 (Step S201). Hereby, an image as illustrated in FIG. 3B is displayed on the display 91.

In Step S202, the arithmetic unit 42 creates a work program 54 for causing the robot arm 2 and the end effector 3 to perform an operation represented by an input operation of the developer to the teaching pendant 9 in cooperation. This work program 54 includes a part defining a robot operation performed by the robot arm 2 and a part defining an end effector operation performed by the end effector 3. Particularly, the arithmetic unit 42 creates the part defining the end effector operation in the work program 54, based on the API 521 and the operation macro code 522 obtained from the memory unit 34 of the end effector 3.

In Step S203, the arithmetic unit 42 transmits the work program 54 created in Step S202 to the communicator 31 of the end effector 3 via the communicator 41, and the communicator 31 of the end effector 3 saves the work program 54 received from the communicator 41 in the memory unit 34 (Step S203). In this way, as shown in FIG. 6, the work program 54 defining the operation to be performed by the robot arm 2 and the end effector 3 attached to the robot arm 2 is saved in the memory unit 34 of the end effector 3.

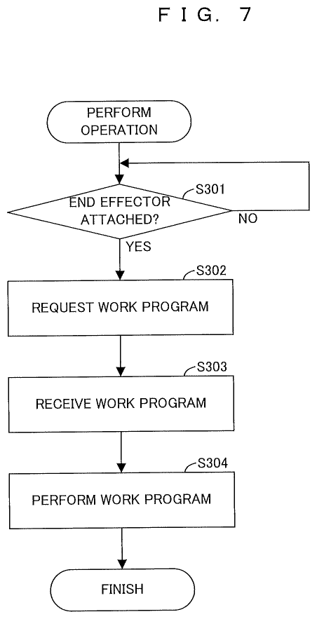

FIG. 7 is a flow chart for causing the robot arm and the end effector to perform the operation. The flow chart of FIG. 7 is performed by the arithmetic unit 42 of the robot controller 4. In Step S301, the arithmetic unit 42 judges whether or not the end effector 3 is attached to the robot arm 3 in a manner similar to the above one.

If the attachment of the end effector 3 to the robot arm 2 is confirmed (“YES” in Step S301), the arithmetic unit 42 transmits a program request command requesting the work program 54 to the communicator 31 of the end effector 3 via the communicator 41 (Step S302). The communicator 31 of the end effector 3 having received the program request command reads out the work program 54 from the memory unit 34 and transmits this to the communicator 41, and the communicator 41 receives this from the communicator 31 of the end effector 3 (Step S303). Then, the arithmetic unit 42 executes the work program 54 received by the communicator 41, thereby causing the robot arm 2 and the end effector 3 to perform the operation specified by the work program 54 (Step S304). At this time, the arithmetic unit 42 executes the API 521 corresponding to each operation represented by the work program 54 to transmit the operation macro code 522 corresponding to the API 521 to the end effector 3 and cause the end effector 3 to perform the operation represented by the operation macro code 522.

In the embodiment configured as described above, the memory unit 34 for storing the control information (API 521 and operation macro code 522) used by the robot controller 4 to control the end effector 3 is provided in the end effector 3. Therefore, by obtaining the control information from the memory unit 34 provided in the end effector 3 to be controlled, the robot controller 4 can reliably obtain the control information corresponding to this end effector 3 (Steps S102 to S104).

Further, the end effector 3, which is hardware, and the control information (API 521 and operation macro code 522), which is software, can be centrally managed. As a result, a mistake of using wrong control information for the end effector 3 can be suppressed and a management burden of the hardware and software is reduced.

Further, if the end effector 3 is attached to the robot arm 2 (robot) (Step S101), the robot controller 4 obtains the control information from the memory unit 34 (Steps S102 to S104). In such a configuration, the control information corresponding to the end effector 3 attached to the robot arm 2 can be reliably obtained.

Further, the robot controller 4 causes the robot arm 2 and the end effector 3 to perform a predetermined operation in cooperation, and this operation includes the robot operation assigned to the robot arm 2 and the end effector operation assigned to the end effector 3. In contrast, the robot controller 4 causes the end effector 3 to perform the end effector operation by controlling the end effector 3 based on the control information obtained from the memory unit 34 (Step S304). In such a configuration, the robot controller 4 can cause the robot arm 2 and the end effector 3 to perform a predetermined operation while precisely controlling the end effector 3 based on the control information corresponding to the end effector 3 attached to the robot arm 2.

Further, the robot controller 4 creates the work program 54 defining the end effector operation based on the control information and saves it in the memory unit 34 of the end effector 3 (Steps S202 to S203). Then, the robot controller 4 causes the end effector 3 to perform the end effector operation by executing the work program 54 obtained from the memory unit 34 (Steps S302 to S304). In such a configuration, the work program 54 defining the end effector operation to be performed by the end effector 3 is created based on the control information corresponding to the end effector 3 and saved in the memory unit 34 of the end effector 3. When performing the operation, the robot controller 4 obtains the work program 54 from the memory unit 34 of the end effector 3 and executes this program. Therefore, the robot controller 4 can reliably cause the end effector 3 to perform the end effector operation based on the work program 54 corresponding to the end effector 3.

Further, the work program 54 for causing the end effector 3 to perform the operation is integrally managed together with the end effector 3. Thus, it is possible to suppress a mistake of breaking the end effector 3 and the robot arm 2 by using the wrong work program 54 for the end effector 3.

Further, the work program 54 further specifies the robot operation, and the robot controller 4 causes the robot arm 2 to perform the robot operation and causes the end effector 3 to perform the end effector operation by executing the work program 54 obtained from the memory unit 34 (Step S304). In such a configuration, the work program 54 defining the operation to be performed by the robot arm 2 and the end effector 3 is created based on the control information corresponding to the end effector 3 (Step S202) and saved in the memory unit 34 of the end effector 3 (Step S203). When performing the operation, the robot controller 4 obtains the work program 54 from the memory unit 34 of the end effector 3 (Step S303) and executes this (Step S304). Therefore, the robot controller 4 can reliably cause the robot arm 2 and the end effector 3 to perform the operation.

Further, the robot controller 4 can control the display on the display 91 of the teaching pendant 9 by the pendant controller 43. In contrast, the HTML file 53 (display information) for causing the display 91 to display the model image 531 (model) of the end effector 3 and the setting screen 532 for setting the operation of the end effector 3 is saved in the memory unit 34 of the end effector 3. In accordance with the HTML file 53 obtained from the memory unit 34 of the end effector 3 in Steps S103 to S104, the robot controller 4 displays the model image 531 and the setting screen 532 on the display 91 (Step S201). In such a configuration, the robot controller 4 can reliably display the model image 531 of the end effector 3 and the setting screen 532 for setting the operation of the end effector 3 on the display 91 based on the HTML file 53 obtained from the memory unit 34 of the end effector 3.

Further, the HTML file 53 is written in HTML. In such a configuration, the memory unit 34 of the end effector 3 functions as a web server. If the robot controller 4 transmits an HTTP request requesting the HTML file 53 to the memory unit 34, the memory unit 34 transmits the HTML file 53 as an HTTP response to the robot controller 4. In this way, the display on the display 91 based on the HTML file 53 can be easily performed by HTTP communication between the robot controller 4 and the memory unit 34 of the end effector 3.

Further, since contents to be displayed on the display 91 need not be prepared in advance in the robot controller 4, the developer of the end effector 3 can freely design and add contents to be displayed on the display 91. Further, data compatibility in the end effector 3 can be ensured for changes caused by upgrading.

Further, the control information includes the API 521 and the operation macro code 522 for causing the end effector 3 to perform a predetermined operation (FIG. 3A), and the robot controller 4 causes the end effector 3 to perform the operation 521 represented by the operation macro code 522 by executing the API 521 to transmit the operation macro code 522 to the end effector 3. In such a configuration, the robot controller 4 can reliably obtain the API 521 and the operation macro code 522 corresponding to the end effector 3 by obtaining the API 521 and the operation macro code 522 from the memory unit 34 provided in this end effector 3 to be controlled.

Depending on the end effector 3, the end effector 3 may have a data acquisition function of obtaining data on the work W such as a camera or pressure sensitive sensor, and the robot controller 4 has been required to perform a signal processing on this data. Accordingly, to deal with such a case, some robot controllers 4 have been equipped with an arithmetic function of performing this signal processing. However, in a situation of using the end effector 3 that does not obtain this data, the robot controller 4 is equipped with an excessive arithmetic function. Accordingly, the robot controller 4 may be configured as in the following modification.

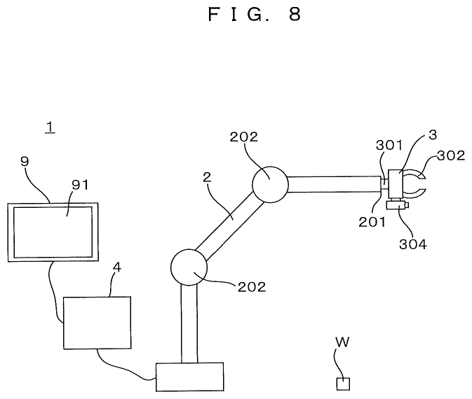

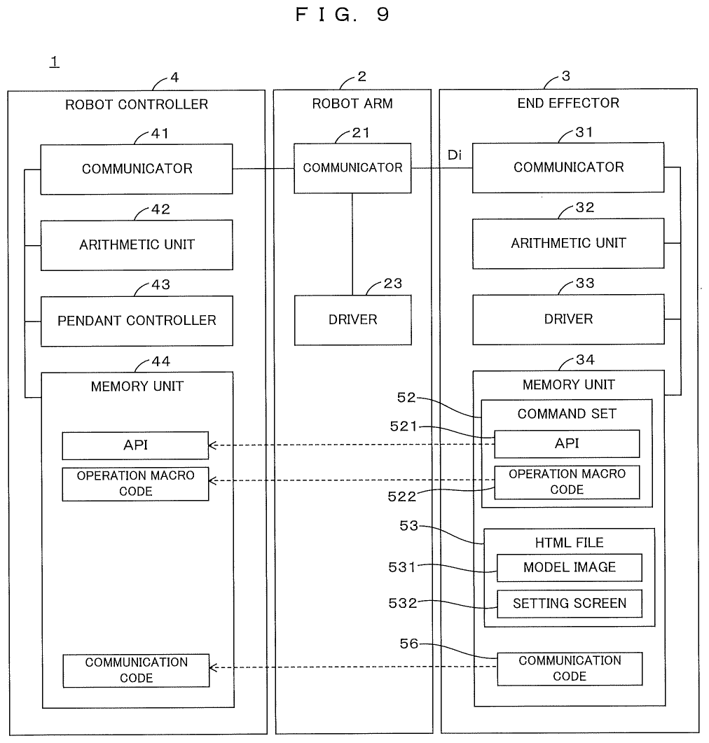

FIG. 8 is a diagram schematically showing a modification of the robot system according to the invention, and FIG. 9 is a block diagram showing an electrical configuration of the robot system of FIG. 8. An example shown in FIGS. 8 and 9 is different from that shown in FIGS. 1 and 2 in having a function of imaging a work W. Accordingly, the following description is centered on points of difference from the above example and common parts are denoted by the same reference signs and not described.

An end effector 3 of FIG. 8 includes a camera 304 (FIG. 8) attached to an attachment part 301 and an arithmetic unit 32 (FIG. 9) configured to perform an image processing (signal processing) on an image captured by the camera 304. This arithmetic unit 32 is a processor such as a CPU or GPU (Graphics Processing Unit). Image processings to be performed by the arithmetic unit 32 include, for example, a processing of extracting a feature value of the work W from an image captured by the end effector 3 and a processing of calculating the two-dimensional or three-dimensional shape of the work W from the image captured by the camera 304. Further, a communication code 56 for instructing the transmission of data Di (feature value, two-dimension or three-dimension shape, etc.) obtained by the image processing by the arithmetic unit 32 from the communicator 31 of the end effector 3 to the communicator 41 of the robot controller 4 is saved in the memory unit 34.

The communication code 56 is read out from the memory unit 34 of the end effector 3 according to Steps S102 to S104 described above, transmitted to the communicator 41 of the robot controller 4 and saved in the memory unit 44. If the robot controller 4 transmits the communication code 56 to the communicator 31 of the end effector 3, the arithmetic unit 32 of the end effector 3 images the work W by the camera 304 to obtain an image and transmits data Di obtained by performing an image processing on this image from the communicator 31 to the robot controller 4. Hereby, the robot controller 4 can obtain the data Di.

In such a modification, the end effector 3 includes the camera 304 (data acquirer) obtaining the image of the work W (data on the work) and the arithmetic unit 32 configured to perform the image processing (signal processing) on the image captured by the camera 304. In such a configuration, since the end effector 3 includes the arithmetic unit 32 configured to perform the image processing, the robot controller 4 is not required to perform this processing. Therefore, the robot controller 4 does not need to be equipped with an excessive arithmetic function.

The robot arm 2, the end effector 3 and the robot controller 4 can be respectively connected in various modes. This point is described, taking the connection between the end effector 3 and the robot controller 4 as an example.

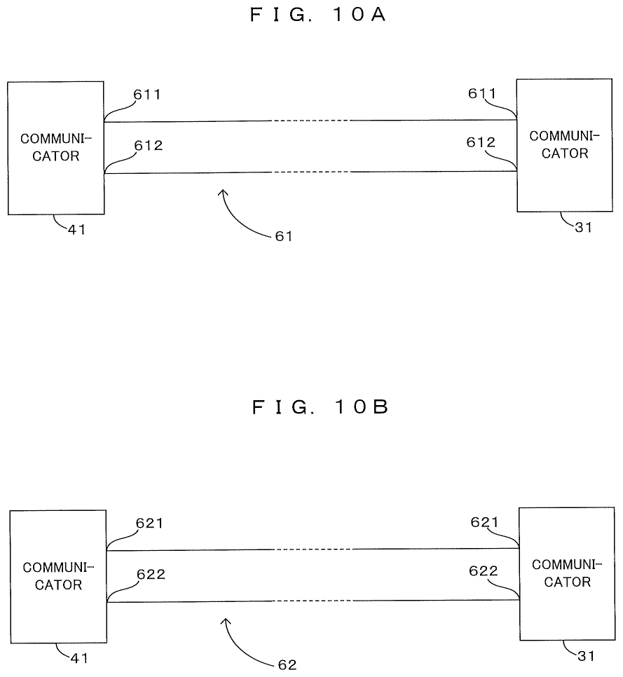

FIG. 10A is a diagram schematically showing a first example of the connection mode of the respective communicators of the robot controller and the end effector. The communicator 41 of the robot controller 4 and the communicator 31 of the end effector 3 are connected by a USB (Universal Serial Bus) 61. Out of a plurality of end points of the USB 61, an end point 611 (one end point) is used for communication between the communicator 41 and the communicator 31. That is, the communication of the API 521, the operation macro code 522, the HTML file 53 or the data Di described above is performed using the end point 611. Further, out of the plurality of end points of the USB 61, an end point 612 (another end point) different from the end point 611 is used by the robot controller 4 to use the memory unit 34 of the end effector 3 as a storage.

In such a modification, the control information can be transmitted from the memory unit 34 of the end effector 3 to the robot controller 4 using the end point 611 of the USB. Further, the end point 612 used by the robot controller 4 to use the memory unit 34 of the end effector 3 as the storage is provided in the USB 61. Therefore, the robot controller 4 can recognize the contents in the memory unit 34 of the end effector 3 as a file and display these as the file on the display 91 by using the end point 612. As a result, the developer can easily refer to the contents of the memory unit 34 of the end effector 3 and the developer's burden can be reduced.

FIG. 10B is a diagram schematically showing a second example of the connection mode of the respective communicators of the robot controller and the end effector. The communicator 41 of the robot controller 4 and the communicator 31 of the end effector 3 are connected by a LAN (Local Area Network) 62. Out of a plurality of ports of the LAN 62, a port 621 (one port) is used for communication between the communicator 41 and the communicator 31. That is, the communication of the API 521, the operation macro code 522, the HTML file 53 or the data Di described above is performed using the port 621. Further, out of the plurality of ports of the LAN 62, a port 622 (another port) different from the port 621 is used by the robot controller 4 to use the memory unit 34 of the end effector 3 as a storage.

In such a modification, the control information can be transmitted from the memory unit 34 of the end effector 3 to the robot controller 4 using the port 621 of the LAN. Further, the port 622 used by the robot controller 4 to use the memory unit 34 of the end effector 3 as the storage is provided in the LAN 62. Therefore, the robot controller 4 can recognize the contents in the memory unit 34 of the end effector 3 as a file and display these as the file on the display 91 by using the port 622. As a result, the developer can easily refer to the contents of the memory unit 34 of the end effector 3 and the developer's burden can be reduced.

As just described, in the above embodiment, the robot system 1 corresponds to an example of a “robot system” of the invention, the robot arm 2 corresponds to an example of a “robot” of the invention, the end effector 3 corresponds to an example of an “end effector” of the invention, the camera 304 corresponds to an example of a “data acquirer” of the invention, the arithmetic unit 32 corresponds to an example of an “arithmetic unit” of the invention, the memory unit 34 corresponds to an example of a “memory unit” of the invention, the robot controller 4 corresponds to an example of a “robot controller” of the invention, the arithmetic unit 42 corresponds to an example of a “control unit” of the invention, the robot arm 2 and the robot controller 4 cooperate to function as an example of a “robot device” of the invention, the API 521 and the operation macro code 522 correspond to an example of “control information” of the invention, the operation macro code 522 corresponds to an example of an “execution code” of the invention, the HTML file 53 corresponds to an example of “display information” of the invention, the work program 54 corresponds to an example of a “work program” of the invention, the USB 61 corresponds to an example of a “USB” of the invention, the end point 611 corresponds to an example of “one end point” of the invention, the end point 612 corresponds to an example of “another end point” of the invention, the LAN 62 corresponds to an example of a “LAN” of the invention, the port 621 corresponds to an example of “one port” of the invention, the port 622 corresponds to an example of “another port” of the invention, the display 91 corresponds to an example of a “display” of the invention, and the work W corresponds to an example of a “work” of the invention.

Note that the invention is not limited to the above embodiment and various changes other than those described above can be made without departing from the gist of the invention. For example, a specific example of the robot equipped in the robot system 1 is not limited to the robot arm 2 and may be a conveyor robot such as an AGV (Automatic Guided Vehicle).

Note that the communication between the communicator 41 of the robot controller 4 and the communicator 31 of the end effector 3 can be carried out without via the robot arm 2. Particularly, in the case of carrying out wireless communication between the communicator 41 and the communicator 31, the communication may not be carried out via the robot arm 2.

Further, various specific languages for describing the operation macro code 522 are supposed. For example, the operation macro code 522 can be described in a binary language corresponding to the arithmetic unit 42 (CPU) mounted in the robot controller 4.

Further, the operation macro code 522 may be described in an intermediate code such as a JAVA bytecode. In this way, the robot controller 4 can execute the operation macro code 522 without depending on a CPU (arithmetic unit 42) thereof.

Alternatively, the operation macro code 522 may be described in an interpreter language such as PYTHON. In this way, the robot controller 4 can execute the operation macro code 522 without depending on the arithmetic unit 42 (CPU) thereof.

Further, various specific configurations of the robot controller 4 for controlling the robot arm 2 and the end effector 3 are supposed, and the specific configuration may be, for example, a desktop computer or laptop computer.

Further, a method for transmitting the model image 531 and the setting screen 532 to the robot controller 4 is not limited to the aforementioned method using the HTML file 53. Further, transmission timings of the model image 531 and the setting screen 532 need not be simultaneous and may be different.

Further, a transmission timing of the control information such as the API 521 and the operation macro code 522 from the memory unit 34 of the end effector 3 to the robot controller 4 is not limited to the timing of attaching the end effector 3 to the robot arm 2 as described above. Therefore, the following configuration may be, for example, adopted.

In this example, an ID for identifying the end effector 3 is saved in the memory unit 34 of the end effector 3. Further, the robot controller 4 obtains the control information and the ID of the robot arm 2 from the memory unit 34 of the end effector 3 in a state detached from the robot arm 2, for example, by wireless communication, and associates these and saves these in the memory unit 44.

If the end effector 3 is attached to the robot arm 2, the ID saved in the memory unit 34 of the end effector 3 is transmitted to the robot controller 4. Then, the robot controller 4 controls the end effector 3 attached to the robot arm 2 based on the control information corresponding to the received ID.

### REFERENCE SIGN LIST

1 . . . robot system
2 . . . robot arm (robot, robot device)
3 . . . end effector
304 . . . camera (data acquirer)
32 . . . arithmetic unit
34 . . . memory unit
4 . . . robot controller (robot device)
42 . . . arithmetic unit (control unit)
43 . . . . GUI
521 . . . . API (control information)
522 . . . operation macro code (control information)
53 . . . . HTML file (display information)
54 . . . work program
61 . . . . USB
611 . . . end point (one end point)
612 . . . end point (another end point)
62 . . . . LAN
621 . . . port
622 . . . port
91 . . . display
W . . . work

1. A robot system, comprising:
a robot;
an end effector to be detachably attached to the robot; and
a robot controller configured to control the robot and the end effector,
wherein the end effector includes a memory unit that saves control information used by the robot controller to control the end effector, and
the robot controller controls the end effector by the control information obtained from the memory unit.

2. The robot system according to claim 1, wherein the robot controller obtains the control information from the memory unit if the end effector is attached to the robot.

3. The robot system according to claim 1 or 2, wherein:
the robot controller causes the robot and the end effector to perform a predetermined operation in cooperation,
the operation includes a robot operation performed by the robot and an end effector operation performed by the end effector, and
the robot controller causes the end effector to perform the end effector operation by controlling the end effector based on the control information obtained from the memory unit.

4. The robot system according to claim 3, wherein the robot controller creates a work program that defines the end effector operation, based on the control information, saves the work program in the memory unit of the end effector and causes the end effector to perform the end effector operation by executing the work program obtained from the memory unit.

5. The robot system according to claim 4, wherein:
the work program further defines the robot operation, and
the robot controller causes the robot to perform the robot operation and causes the end effector to perform the end effector operation by executing the work program obtained from the memory unit.

6. The robot system according to any one of claims 1 to 5, wherein the end effector further includes a data acquirer configured to obtain data on the work and an arithmetic unit configured to perform a predetermined signal processing on the data obtained by the data acquirer.

7. The robot system according to claim 6, wherein:
the data acquirer is a camera that obtains an image of the work, and
the arithmetic unit performs an image processing on the image obtained by the camera.

8. The robot system according to any one of claims 1 to 7, wherein:
the memory unit saves display information for displaying a model of the end effector and a setting screen for setting an operation of the end effector, and
the robot controller performs display on a display according to the display information obtained from the memory unit.

9. The robot system according to claim 8, wherein the display information is described in an HTML (HyperText Markup Language).

10. The robot system according to any one of claims 1 to 9, wherein:
the control information includes an execution code representing an operation to be performed by the end effector, and
the robot controller causes the end effector to perform the operation represented by the execution code by transmitting the execution code to the end effector.

11. The robot system according to claim 10, wherein the execution code is described in an intermediate code.

12. The robot system according to claim 10, wherein the execution code is described in an interpreter language.

13. The robot system according to any one of claims 1 to 12, wherein:
the robot controller and the end effector are connected by a USB (Universal Serial Bus), and
out of a plurality of end points of the USB, one end point is used for communication between the robot controller and the end effector, and another end point different from the one end point is used by the robot controller to use the memory unit of the end effector as a storage.

14. The robot system according to any one of claims 1 to 12, wherein:
the robot controller and the end effector are connected by a LAN (Local Area Network), and
out of a plurality of ports of the LAN, one port is used for communication between the robot controller and the end effector, and another port different from the one port is used by the robot controller to use the memory unit of the end effector as a storage.

15. A robot device, comprising:
a robot to which an end effector is to be detachably attached; and
a robot controller configured to control the robot and the end effector,
wherein the end effector including a memory unit that saves control information used by the robot controller to control the end effector, and
the robot controller controlling the end effector by the control information obtained from the memory unit.

16. A robot controller for controlling a robot and an end effector to be detachably attached to the robot, comprising:
a control unit configured to control the robot and the end effector,
wherein the end effector includes a memory unit that saves control information used by the robot controller to control the end effector, and
the control unit controls the end effector by the control information obtained from the memory unit.

17. An end effector to be detachably attached to a robot, comprising:
a memory unit that saves control information used by a robot controller to control the end effector.

18. An end effector control method, comprising:
obtaining control information used to control an end effector from a memory unit provided in the end effector by a robot controller; and
controlling the end effector by the control information obtained from the memory unit by the robot controller.
